(19) United States
(12) Patent Application Publication
(10) Pub. No.: US 2007/0019026 A1
(43) Pub. Date: Jan. 25, 2007

(54) Printer

(76) Inventors: Jason E. Gibson, Eagle, ID (US); Peter Majewicz, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/189,384

(22) Filed: Jul. 25, 2005

(51) Int. Cl. B41J 29/393

(52) U.S. Cl. 347/19

(57) ABSTRACT

A printer that performs an off-media calibration routine. The printer can receive a user request to print a document, where the document includes a color. The printer can print the document on a print medium. The printer can perform an on-media measurement of the color as printed on the print medium. The printer can perform an off-media measurement of the color as printed on an internal surface of the printer. The printer can use the on-media measurement and the off-media measurement to update a correlation that is used in the off-media calibration routine.

### BACKGROUND

During the course of operation of a printer, print parameters which control printing density and shades can drift. It can be desirable therefore to perform calibrations to restore print parameters to a desired state.

One way a printer may perform a calibration is to (on-media) print a set of test patches on print media. A measurement device (e.g., a densitometer) is used to measure the “on-media” printed test patches. The data from the measurement device is then used to set printing parameters. For ease of discussion, this type of calibration may be referred to as “on-media” calibration.

On-media calibration may be used to accurately set print parameters. However, there are costs associated with such a procedure. Particularly, each calibration cycle can result in consuming media and can be disruptive to customer print jobs. Because of these costs (time, money, materials,. user involvement), it may be impractical to perform on-media calibration automatically or often.

One alternative to on-media calibration is “off-media calibration”. In off-media calibration, calibration is performed by (off-media) printing a set of test patches, not on print media used for printing, but on a substitute surface such as a transport belt surface or some other permanent surface within the printer. In this case a measurement device (e.g., a densitometer) is used to measure the “off-media” printed test patches. The data from the measurement device is then used to set printing parameters.

Off-media calibration has the advantage of not consuming print media and can be performed automatically, with little impact on users. Typically, off-media calibrations rely on correlations that relate off-media measurements of the (off-media) printed test patches to on-media values. Unfortunately, such correlations are prone to inaccuracy over the life of a printer as the characteristics of the off-media printing surface (e.g., a surface of a transport belt) and/or the print media type used in the printer may change.

### BRIEF DESCRIPTION OF THE DRAWINGS

FIG. 1 is a schematic representation of a computing system according to an embodiment of the present invention;

FIG. 2 is a simplified block diagram illustrating certain aspects of a printer controller according to an embodiment of the present invention;

FIG. 3 illustrates a set of test patches;

FIG. 4 is a flow diagram illustrating one example of an off-media calibration routine;

FIG. 5 illustrates a configuration page document that may be printed by a printer that embodies the invention;

FIG. 6 is a flow diagram illustrating how a printer that embodies the invention may use an internally stored document (e.g., a configuration page) to update a set of correlations;

FIG. 7 is a graph of an updated correlation;

FIG. 8A and FIG. 8B is a flow diagram illustrating how a printer that embodies the invention may use a user defined document to update a set of correlations; and

FIG. 9 illustrates a user defined document that includes colored rectangles.

### DESCRIPTION

As used herein, the phrase “printer” refers to any device that includes a printing function. Thus, for example, the phrase “printer” may refer to an inkjet printer, a laser printer, a commercial printing press, a multifunction peripheral (MFP) that includes a printing function, etc. The phrase “color printer” refers to any type of printer that can generate color printed output. The term “colorant” refers to a printer material, such as toner or ink, that is used in a color printer to print an image.

As used herein, the phrase “print medium” refers to a medium that is used by a printer to generate hard-copy output for a user. The phrase “on-media” printing refers to printing on a print medium surface. The phrase “off-media” printing refers to printing on a surface that is not a print medium surface. Printing on a surface of a media transport belt (as described below) is an example of off-media printing.

As used herein, the phrase “off-media measurement” refers to a measurement of a color that is off-media printed. For example, in the non-limiting embodiment described below, off-media measurements are performed on colors printed on the outer surface of a media transport belt.

As used herein, the phrase “on-media” sensor refers to a sensor that can be used to perform on-media measurements of printed colors. The phrase “off-media sensor” refers to a sensor that can be used to perform off-media measurements of printed colors.

### EXAMPLE EMBODIMENT

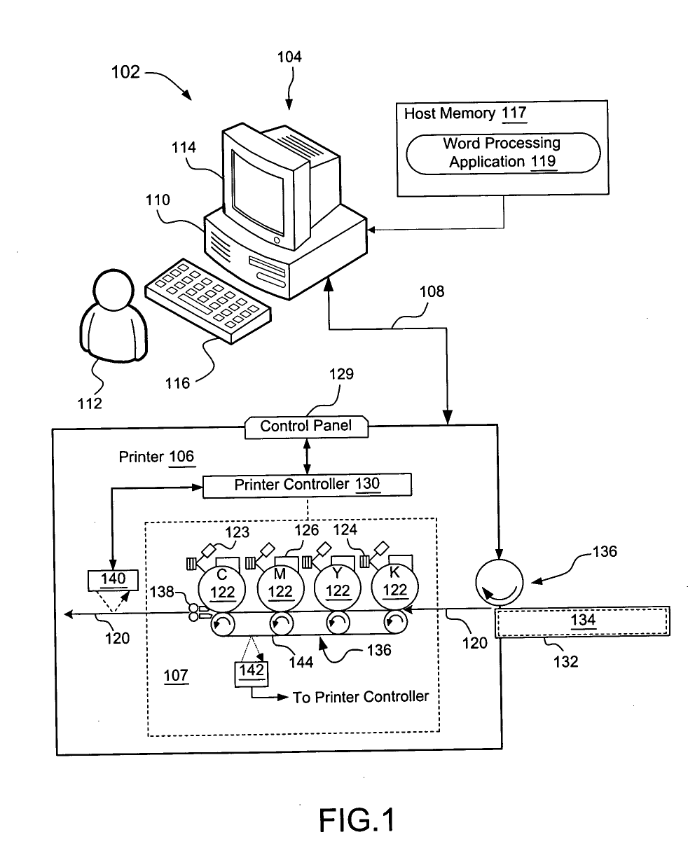

With reference to FIG. 1, shown is an example of a computing system 102 according to an embodiment of the present invention. As shown, the computing system 102 includes a host computer 104 and a color printer 106. The host computer 104 and the printer 106 are connected via a communication link 108.

The host computer 104 includes a central processing unit (CPU) 110, and one or more user interface devices that allow a user (e.g., a user 112) to interact with the host computer 104. The one or more user interface devices include, in this example, a display monitor 114 and a user input device 116 (e.g., a keyboard). The host computer 104 further includes a local memory 117 that stores a word processing application 119.

We will assume in this example embodiment that the word processing application 119 allows the user 112 (by interacting with the host computer 104) to create (i.e., define) original color documents (in electronic form) and to transmit these documents (in the form of print jobs) over the communication link 108 to the printer 106. The printer 106 responds to the print jobs by printing the color documents.

Printer Construction

The printer 106 includes various components that enable it to generate printed output. In this example, the printer 106 includes a print engine 107 that implements an electro-photographic process to generate color printed output. The print engine 107 includes apparatus to deposit four differently colored toners (or colorants) onto a sheet of print medium traveling along a media path 120.

In particular, the print engine 107 includes a set of four photoconductive drums 122 one for each color toner employed by the printer 106. In this example, such colors are Cyan (C), Magenta (M), Yellow (Y) and Black (K). Associated with each photoconductive drum 122 is a laser 123, an optics system 124 and a toner cartridge 126.

The printer 106 further includes, in this example, various other components including a local control panel 129, a printer controller 130, a media tray 132 capable of holding a stack of print media sheets 134, a media transport system 136, a toner fusing system 138, an on-media sensor 140, and an off-media sensor 142.

The media transport system 136 enables the printer 106 to pick a sheet from the top of the media stack 134 and to advance the picked sheet along the pre-defined media path 120. In this example, the media transport system 136 includes a media transport belt 144 for advancing the picked sheet along the media path 120.

The on-media/off-media sensors 140, 142 may each represent any type of sensor that enables the printer 106 to perform respectively the on-media and off-media measurements described below. In the present embodiment, for example, we will assume that both sensors 140, 142 are densitometers capable of optically measuring the density of a printed color. In other embodiments, however, other types of sensors might be used. For example, any sensor that includes a light source and a photo-detector might be used. Example sensors include a colorimeter, a spectrophotometer, a light source/pn junction diode, a light source/CCD, a light source/CMOS array, a light source/CMOS array or any other type of sensing mechanism. It is further noted that in some printer embodiments a single sensor may perform the on-media and off-media measurements.

In this example embodiment, the on-media sensor 140 is positioned with respect to a page that exits the fusing system 138 to enable the on-media measurements described below after all processing steps have been completed, including fusing. The off-media sensor 142 is positioned appropriately with respect to the transport belt 144 to enable the off-media measurements described below.

Printer Controller

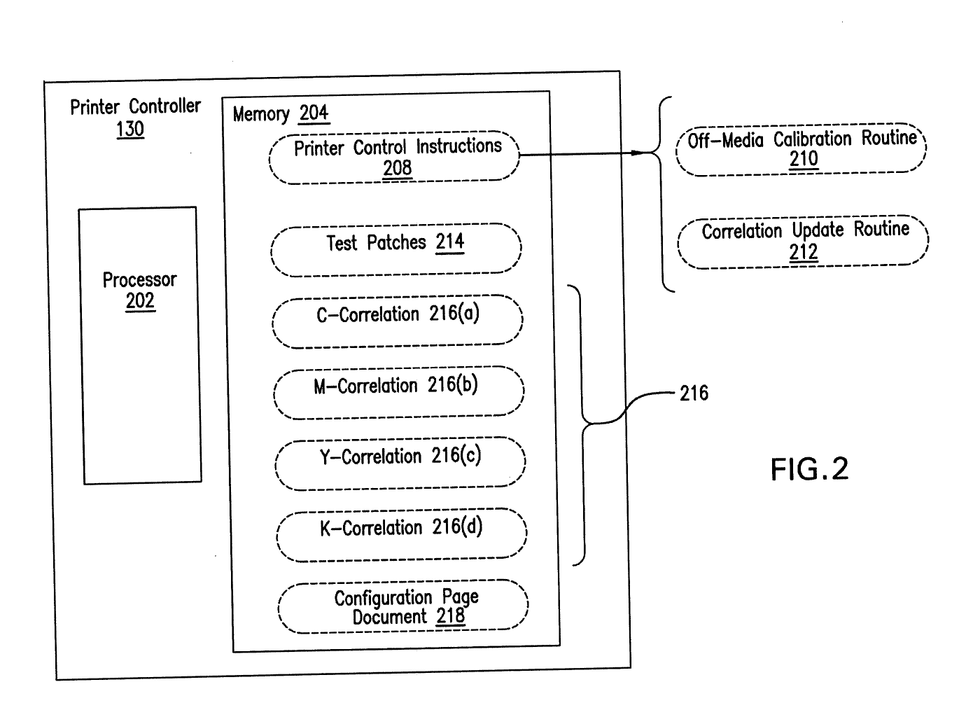

Shown in FIG. 2 is a simplified block diagram illustrating certain aspects of the printer controller 130. As shown, the printer controller 130 includes a processor circuit 202 and a memory 204 that can be accessed by the processor 202. The printer controller 130 may include many other components that are not shown, such as one or more I/O ports, a bus system, etc.

Stored in the memory 204 and executable by the processor 202 to control the operation of the printer 106, are printer control instructions 208. The printer control instructions 208 are executable by the processor 202 to perform various operations including an off-media calibration routine 210 as well as a “correlation update routine” 212. These routines are described further below.

Also stored in the memory 204 is certain information that is used by the printer to perform the calibration routine 210. In particular, the memory 204 stores a set of test patches 214 and a set of four correlations 216 (one for each CMYK toner color).

Each of the four correlations correspond to a particular toner color and is used during an off-media calibration routine to relate off-media measurements of the test patches 214 (as printed using only the corresponding toner color) to predicted on-media values had the test patches 214 instead been printed on print media. In particular, the set of four correlations 216 includes:
1. A first correlation (designated “C-correlation” 216(a)) that corresponds to the Cyan toner color. This correlation relates off-media measurements of a cyan colored (off-media) printed test patch to on-media values.
2. A second correlation (designated “M-Correlation” 216(b)) that corresponds to the Magenta toner color. This correlation relates off-media measurements of a Magenta colored (off-media) printed test patch to on-media values.
3. A third correlation (designated “Y-Correlation” 216(c)) that corresponds to the Yellow toner color. This correlation relates off-media measurements of a Yellow colored (off-media) printed test patch to on-media values; and
4. A fourth correlation (designated “K-Correlation” 216(d)) that corresponds to the Black toner color. This correlation relates off-media measurements of a Black colored (off-media) printed test patch to on-media values.

Also stored in the printer memory 204 are various internally stored pages, such as a configuration page document 218 that may be printed at the request of a user. The user may request the configuration page 218 to be printed by interacting with the control panel 129, for example. As described further below, the configuration page 218 may be used by the correlation update routine 212 to update the correlations 216.

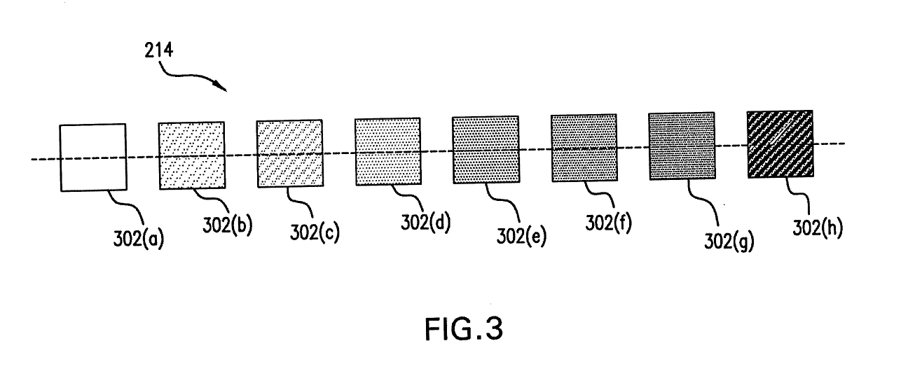

FIG. 3 illustrates the set of stored test patches 214 in this example embodiment. As shown, the set of test patches includes a series of eight halftone test patches 302(a)-(h) that vary in density from light to dark. The test patches are, in this example, equally spaced and arranged to be off-media printed appropriately on the transport belt outer surface so as to permit off-media measurements of the patches by the off-media sensor 142.

Printer General Operation

Generally speaking, in order to print on a sheet of print medium, the printer controller 130 can direct the operation of the lasers 123 to place a latent image onto the respective photoconductive drums 122. Colored toner (e.g., CMY or K) obtained from the respective toner cartridges 126 can be applied to each respective latent image to create toned latent images.

In conjunction with the toned latent images being created, the media transport system 136 can pick the top print medium sheet from the media stack 134 and transport the picked sheet through the printer media path 120. As the print medium is transported along the media path 120, the toned latent images are transferred sequentially to the print medium- thereby printing a multi-color image on the sheet. The multi-color printed image is then fused to the sheet by the toner-to-media fusing system 138.

Printer Off-media Calibration Routine

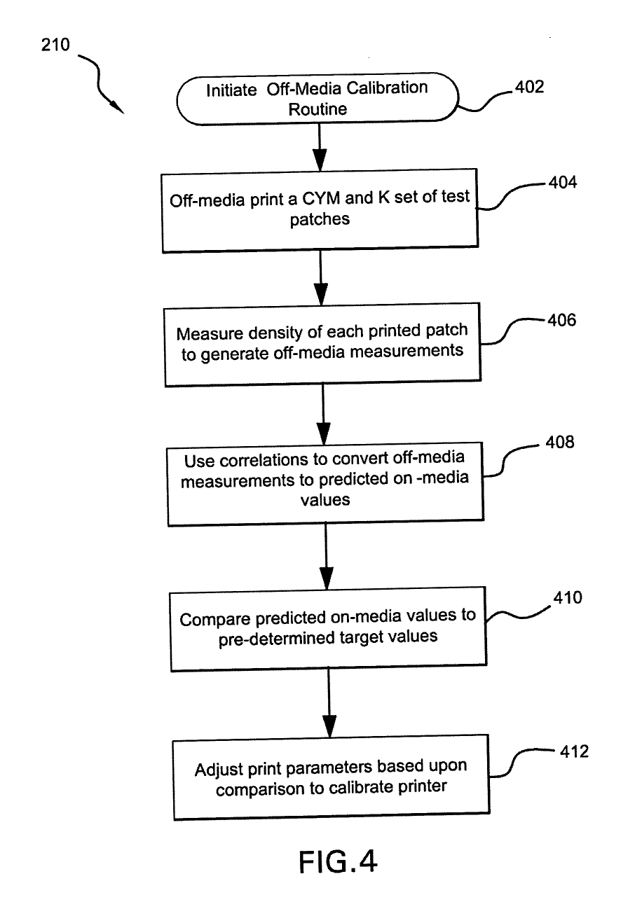

FIG. 4 is a flow diagram illustrating generally the operation of the printer 106 to perform the off-media calibration routine 210. As shown in FIG. 4, the printer 106 initiates the off-media calibration routine at step 402. The printer 106 may be configured to initiate the routine 210 on a scheduled basis, after printing a print job and/or at the request of a user, for example.

At step 404, the printer 106 prints the set of test patches 214 on the outer surface of transport belt four times—once using only the Cyan toner, once using only Magenta toner, once using only Yellow toner and once using only Black toner. As a result, thirty-two (8×4) test patches are off-media printed on the transport belt.

At step 406, the printer uses the off-media sensor 142 to perform an off-media measurement of each one of the thirty-two (off-media) printed test patches. As a result, thirty-two off-media measurements are generated.

At step 408, the printer uses the appropriate correlation (from the set of correlations 216) to convert each of the thirty-two off-media measurements to a predicted on-media density value. This results in thirty-two (predicted) on-media values being generated. By way of example, the printer 106 would use the C-correlation 216(a) at step 408 to convert the eight off-media measurements of the Cyan printed test patches to a corresponding set of eight on-media density values.

At step 410, the printer 106 compares the thirty-two on-media values generated at step 408 to pre-determined target (on-media) values. Based upon this comparison, the printer 106 sets various printing parameters to a desired state thereby calibrating the printer 106 (step 412).

Printer Configuration Page

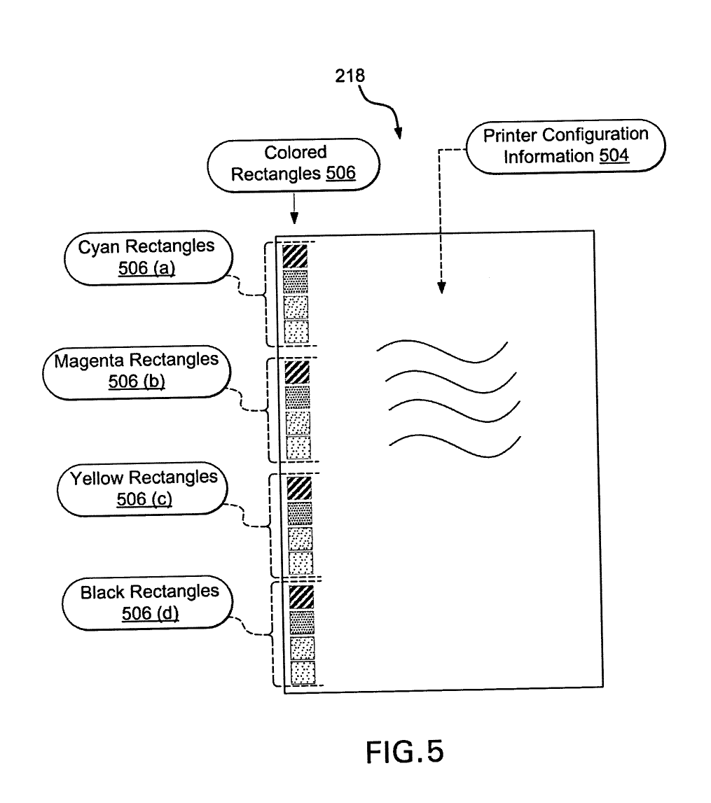

For the discussion that follows, FIG. 5 illustrates aspects of the configuration page 218 that may be printed by the printer 106 in the present embodiment.

As indicated in the figure, the configuration page 218 includes certain configuration information 504 regarding the present status of the printer 106 that a user may find useful. The information 504 may specify, for example, human readable text that specifies printer model number, the printer serial number, the printer IP address, printer memory status, installed personalities, etc.

In addition, the configuration page 218 includes, in this example, a vertical column of colored rectangles 506 that run along the left edge of the page. The colored rectangles 506 include a set of four Cyan colored rectangles 506(a), a set of four Magenta colored rectangles 506(b), a set of four Yellow colored rectangles 506(c) and a set of four Black colored rectangles 506(d). Each of the four sets of rectangles respectively vary in density from light to dark.

Use of Configuration Page to Update Correlations

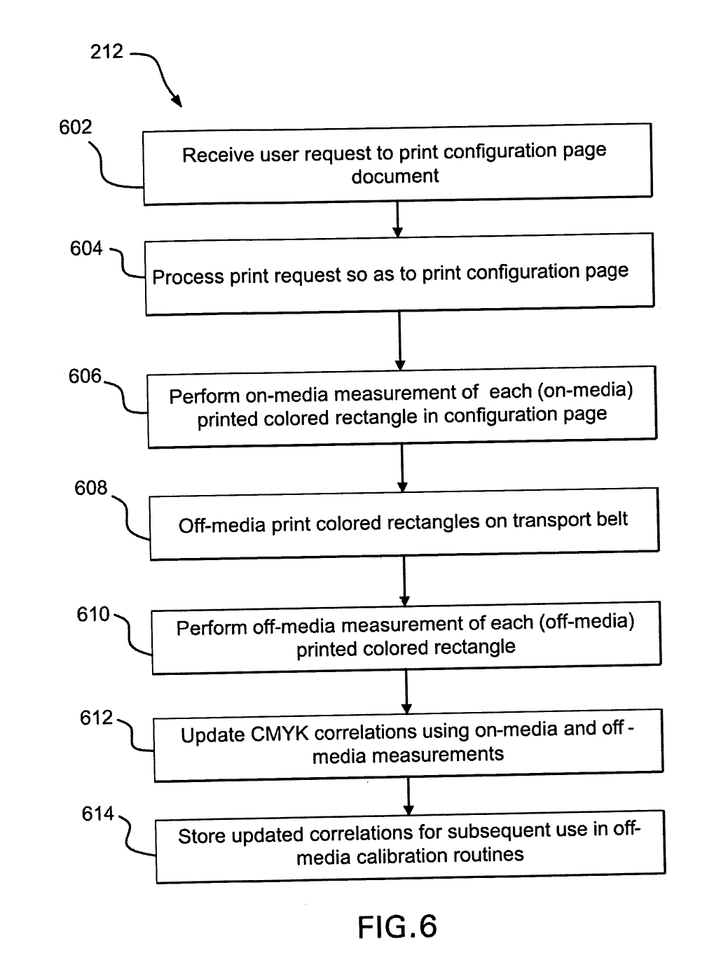

FIG. 6 is a flow diagram illustrating, by way of example, how the printer 106 may use the configuration page 218 to update the correlations 216. At step 602, we assume the printer 106 receives a user request to print the configuration page 218.

At step 604, in response to the user request, the printer 106 begins printing the configuration page. Thus, at step 604, the printer 106 prints the configuration information 504 and the column of colored rectangles 506 on a print medium that is obtained from the medium tray 132.

At step 606, as the printed configuration page 218 exits the fusing system 138, the printer 106 performs (using the on-media sensor 140) an on-media measurement of each one of the sixteen (on-media) printed colored rectangles 506. As a result, sixteen (4×4) on-media measurement values (i.e., one for each on-media printed rectangle) are generated.

At step 608, after the configuration page 218 is completely printed, the printer 106 off-media prints each one of the CMY and K colored rectangles 506 on the surface of the transport belt 144. The rectangles 506 are printed at a location on the belt surface so as to permit off-media measurement by the off-media sensor 142.

At step 610, the printer 106 performs (using the off-media sensor 142) an off-media measurement of each one of the off-media printed colored rectangles 506. As a result, sixteen off-media measurement values (i.e., one for each off-media printed rectangle) are generated.

At step 612, the sixteen on-media measurement values and the sixteen off-media measurement values are used to update the correlations 216. At step 614, the updated correlations are stored in the printer memory 204 for subsequent use in off-media calibrations.

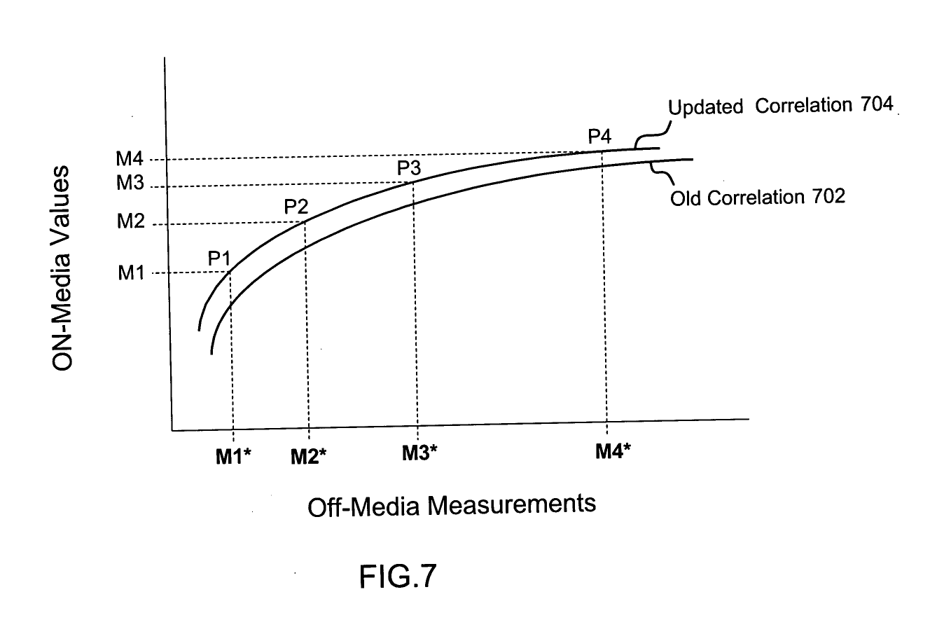

To illustrate how the Cyan correlation 216(a), for example, may be updated at step 612 attention is directed to FIG. 7.

FIG. 7 shows a graph of a first curve 702 and a second curve 704. The first curve 702 represents the C-correlation 216(a) prior to being updated. The second curve 704 represents the C-correlation 216(a) after being updated at step 612.

We assume in FIG. 7 that (M1, M2, M3 and M4) respectively are the on-media measurements generated at step 606 for the on-media printed cyan colored rectangles 506(a). We further assume that (M1*, M2*, M3* and M4*) respectively are the off-media measurement values generated at step 610 for the off-media printed cyan colored rectangles 506(a).

As indicated in FIG. 7, the off-media and on-media values may be used to determine four points on the updated curve (P1, P2, P3, P4). The curve 704 may then be extrapolated based upon these four points.

Use of User Defined Document to Update Correlations

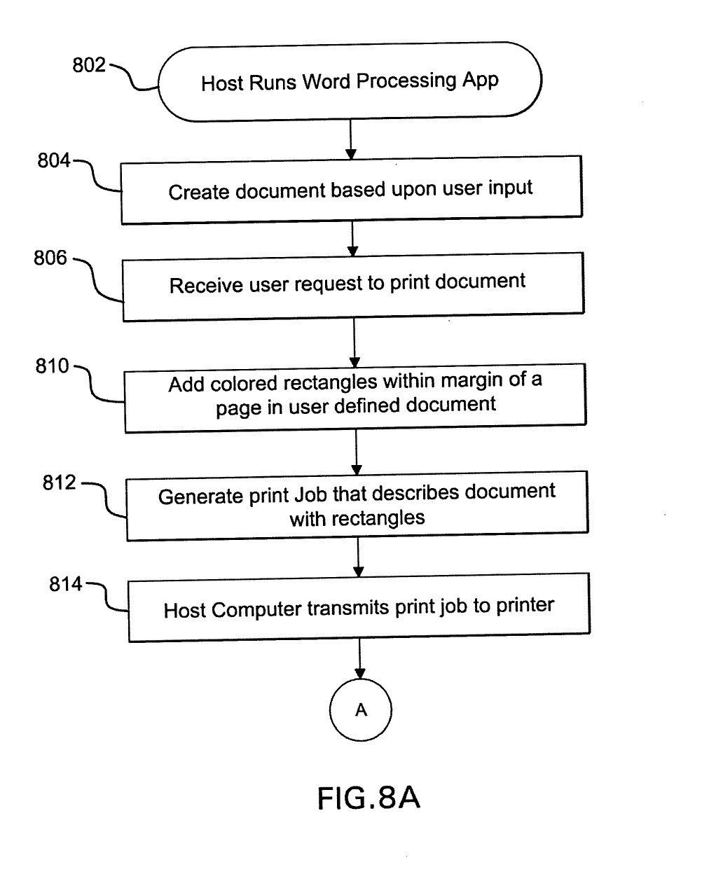

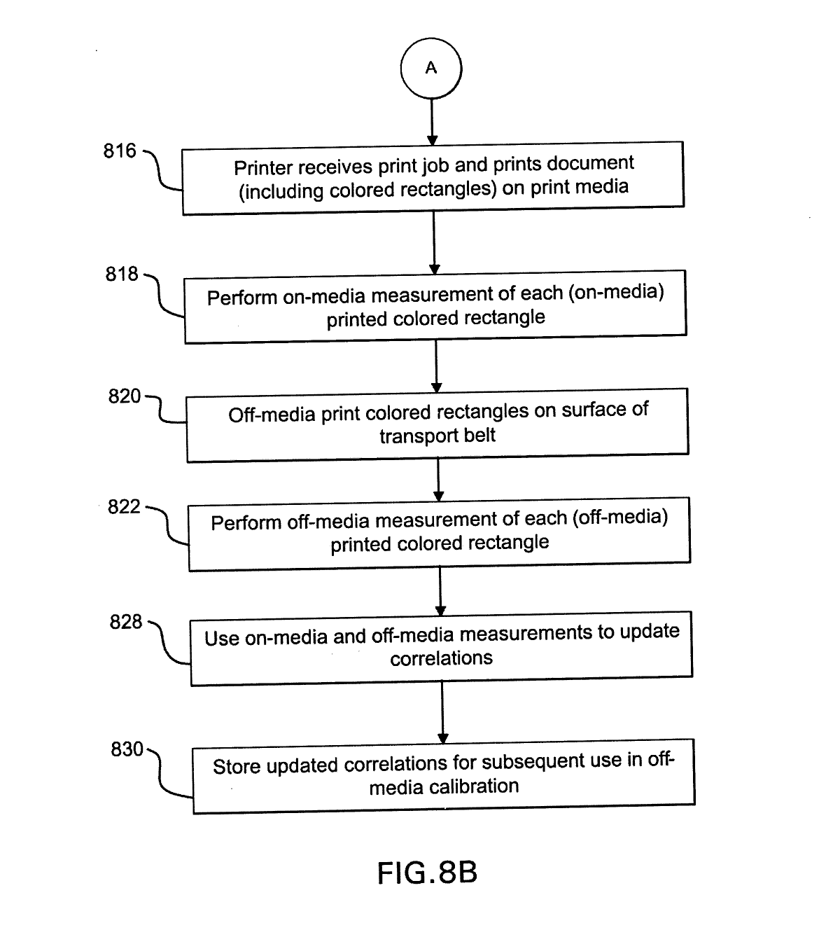

As described above, a printer according to embodiments of the invention, may use internally stored documents (e.g., a configuration page) to update correlations that are used in an off-media calibration procedure. FIG. 8A and FIG. 8B is a flow diagram that illustrates how the printer 106 may also use user defined documents to update these same correlations.

Beginning at step 802, the host computer begins executing the word processing application 119. At step 804, the user 112 interacts with the word processing application 119 to create/define a document. The document may comprise user defined text as well as user defined images (e.g., digital photos, charts, etc.), for example.

At step 806, the host computer receives a request from the user to print the document. In addition, we also assume in this example that the user inputs a request that indicates he/she wishes the document to be used to update the printer off-media calibration correlations.

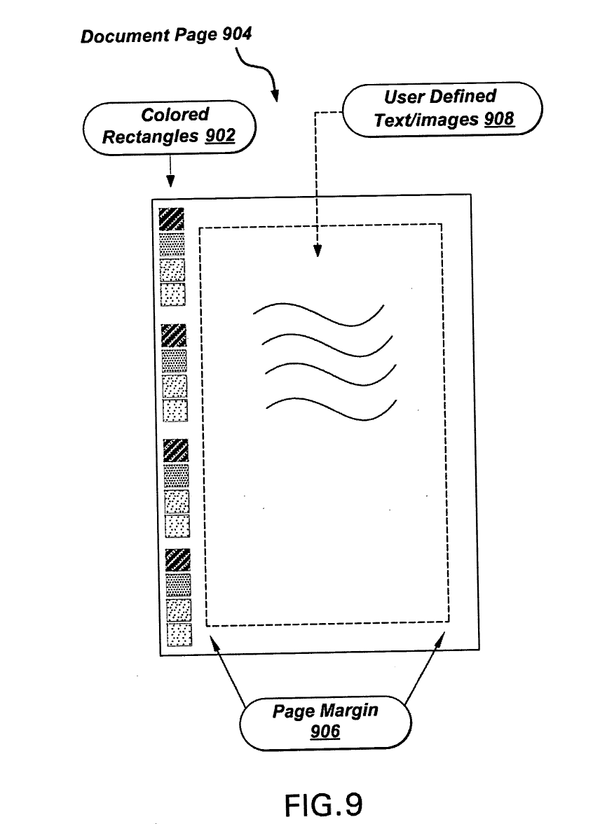

In response to the user input received at step 806, the host computer proceeds to automatically perform the following acts:
1. At step 810, the host computer automatically inserts a column of colored rectangles 902 (see FIG. 9) within the left-hand margin of a particular page (target page) in the document. According to one implementation, for example, the rectangles are placed in the last page of the document. Furthermore, the colored rectangles may be configured in the same manner as the configuration page described above. Accordingly, the column of colored rectangles may include a set of cyan rectangles, a set of magenta rectangles, a set of yellow rectangles and a set of black rectangles.
2. At step 812, the host computer generates a print job to print the user defined document that includes the inserted column of rectangles. The print job may include a special command that directs the printer to use the document to update the correlations 216.
3. At step 814, the host computer transmits the print job to the printer 106.

At step 816, the printer 106 receives the print job and prints the document, including the colored rectangles, on print media. The colored rectangles are therefore on-media printed within the target page margin.

At step 818, the printer 106 uses the on-media sensor 140 to perform on-media measurements of the colored rectangles that were (on-media) printed at step 816. This results in a set of on-media measurements of the colored rectangles being generated.

At step 820, the printer 106 off-media prints the colored rectangles on the outer surface of the media transport belt. The colored rectangles are printed on the belt surface so as to permit the off-media sensor 142 to measure each (off-media) printed rectangle.

At step 822, the printer 106 uses the off-media sensor 142 to perform a measurement of each off-media printed colored rectangle. This results in a set of off-media measurements being generated.

At step 824, the printer 106 uses the set of on-media measurements and the set of off-media measurements to update the set of correlations 216. This step may be performed in a similar manner as described above with reference to FIG. 7.

At step 826, the printer 106 stores the set of updated correlations 216 for subsequent use in off-media calibrations.

FIG. 9 shows how the host computer 104 may arrange a column of colored rectangles 902 in a target page 904 of a user defined document. As shown, the page 904 includes a margin 906 and the colored rectangles are arranged within the margin. As indicated, the page 904 may also include user defined text and images (e.g., digital photos) 908 that were defined by the user 112.

The present invention may also be embodied in the form a computer readable medium having computer executable instructions embodied therein. For example, a memory (e.g., the memory 204) that embodies the printer control instructions 208 represents an embodiment of the invention.

In the context of this document, “a computer readable medium” can be any means that can contain, store, communicate, propagate, or transport the program for use by or in connection with an instruction execution system, apparatus or device. A computer readable medium can be, for example (the following is a non-exhaustive list), a magnetic, optical, or semiconductor based storage device

Although specific embodiments of the invention has been described and illustrated, the invention is not to be limited to the specific forms or arrangements of parts so described and illustrated. For example, the off-media printing described above was performed by printing on a media transport belt. In other embodiments, off-media printing may be performed on any surface within a printer that is not print media. For example, the internal surface might be a photoconductive surface (e.g., a photoconductive drum surface or a photoconductive belt surface), an image transfer belt or an image transfer roller. In implementations where the internal surface is a photoconductive surface, the off-media measurements may be performed by measuring a voltage potential on the photoconductor, for example.

Additionally, in other embodiments, certain operations performed by the host computer and/or the printer may be shifted to other devices. For example, the printer 106 (or a print server) may be configured to insert colors (e.g., the colored rectangles 902) into a user defined document rather than the host computer.

In the embodiments described above, a column of sixteen colors on a single page is used to update the set of correlations 216. It is understood that in other embodiments, more or less than sixteen colors may be used. Also, the colors may not be configured in a column, may be printed at different locations in a document and may even be located across multiple pages in a document.

Accordingly, the invention is limited only by the claims and equivalents thereof.

1. In a printer that performs an off-media calibration routine, a method comprising:
(a) receiving a user request to print a document, where the document includes human readable text and a color;
(b) in response to the user request, printing the document on a print medium;
(c) performing an on-media measurement of the color as printed on the print medium;
(d) performing an off-media measurement of the color as printed on an internal surface of the printer;
(e) using the on-media measurement and the off-media measurement to update a correlation that is used in the off-media calibration routine;
wherein the correlation relates off-media measurement values of colors printed on the internal surface of the printer to on-media values.

2. The method of claim 1, wherein the internal surface is a media transport belt.

3. The method of claim 1, wherein the internal surface is one of:
a photoconductive surface;
an image transfer surface; and
an image transfer roller.

4. The method of claim 1, wherein the document is a printer configuration page that is locally stored by the printer and describes the current configuration of the printer.

5. The method of claim 1, wherein the document is a printer configuration page that provides the printer model number.

6. The method of claim 1,
wherein the receiving step includes receiving a print job from a remote host computer that was used by the user to initially create the document;
wherein the print job describes the document.

7. The method of claim 1, wherein the printer uses one of the following to print the document: toner and ink.

8. The method of claim 1, further comprising:
(f) after the correlation is updated, performing an off-media printer calibration to calibrate the printing device, wherein the performing step uses the updated correlation.

9. The method of claim 1, wherein the on-media measurement and the off-media measurement are each performed using at least one optical sensor.

10. In a printer, a method comprising:
(a) receiving a request to print a locally stored configuration page, where the page includes printer configuration information and a plurality of colors;
(b) printing the configuration page by printing the configuration information and the plurality of colors on a print medium,
(c) performing an on-media measurement of each one of the plurality of colors as printed on the print medium, thereby generating a set of on-media measurements;
(d) off-media printing the plurality of colors on an internal surface of the printer;
(e) performing an off-media measurement of each one of the plurality colors as printed on the internal surface, thereby generating a set of off-media measurements;
(f) using the set of on-media measurements and the set of off-media measurements to update a correlation; and
(g) subsequently using the updated correlation in an off-media calibration routine.

11. The method of claim 10, wherein the correlation is between off-media measurement values of colors as printed on the internal surface to on-media measurement values of the same colors as printed on a print medium.

12. The method of claim 11, wherein the configuration information specifies a model number of the printer, a serial number of the printer, and an IP address of the printer.

13. The method of claim 11, wherein the internal surface of the printer is one of the following: a media transport belt surface; a photoconductive surface; an image transfer roller; and an image transfer belt.

14. In a system that includes a host computer and a printer, a method comprising:
by the host computer:
receiving input from a user that defines text;
generating a print job that describes a document, where the document includes the text and also a set of colors;
transmitting the print job to the printer;
by the printer:
receiving the print job;
printing the document, including the colors, on print media;
performing on-media measurements of the colors printed on the print media;
printing the colors on an internal surface of the printer;
performing off-media measurements of the colors printed on the internal surface;
using the on-media measurement and the off-media measurement to update a correlation that is used by the printer in an off-media calibration routine.

15. The method of claim 14, wherein the correlation relates off-media measurement values of colors printed on the printer internal surface to on-media values.

16. The method of claim 14, wherein the internal surface is a media transport belt.

17. The method of claim 14, wherein the set of colors are configured as colored rectangles that are printed within a margin of the document.

18. The method of claim 14, wherein the print job includes at least one command that directs the printer to update the correlation.

19. A printer, comprising:
means for printing a document, on print media, that includes human readable text and a color located within a margin of the document;
means for measuring the color as printed on the print media so as to generate an on-media measurement of the color;
means for printing the color on an internal surface of the printer;
means for measuring the color as printed on the internal surface so as to generate an off-media measurement of the color;
means for using the on-media measurement and off-media measurement to update a correlation that is used in an off-media calibration routine.

20. The printer of claim 19, wherein the correlation relates off-media measurement values of colors printed on the internal surface of the printer to on-media values.

21. The printer of claim 19, wherein the correlation relates off-media measurement values of colors printed on the internal surface of the printer to on-media values and the internal surface is one of:
a media transport belt;
an image transfer surface; and
a photoconductive surface.

22. The printer of claim 19, wherein the document is a configuration page.

23. The printer of claim 19, wherein the document is received by the printer in form of a print job.

24. A computer-readable medium storing computer executable instructions for performing the steps of:
(a) receiving a user request to print a document, where the document includes human readable text and a column of colored rectangles that is arranged to one side of the text;
(b) in response to the user request, printing the document on a print medium;
(c) performing an on-media measurement of the colored rectangles as printed on the print medium;
(d) performing an off-media measurement of the colored rectangles as printed on an internal surface of the printer;
(e) using the on-media measurement and the off-media measurement to update a correlation that is used in an off-media calibration routine.

25. The computer-readable medium of claim 24, wherein the correlation relates off-media measurement values of colors printed on the internal surface of the printer to on-media values.

26. The computer-readable medium of claim 25, wherein the internal surface of the printer is one of the following:
a transport belt;
a photoconductive surface;
an image transfer belt; and
an image transfer roller.

27. The computer-readable medium of claim 26, where the column of colored rectangles include a first set of cyan colored rectangles, a second set of magenta colored rectangles, a third set of yellow colored rectangles, and a fourth set of black colored rectangles.

28. The computer-readable medium of claim 27, wherein the colored rectangles are printed within a defined margin of the document.

29. The computer-readable medium of claim 28, wherein each set of rectangles vary in density from light to dark.
